(19) United States
(12) Patent Application Publication
(10) Pub. No.: US 2010/0085972 A1
(43) Pub. Date: Apr. 8, 2010

(54) METHOD AND ROUTING DEVICE FOR ADVERTISING ROUTING INFORMATION

(75) Inventors: Gang Yan, Shenzhen (CN); Jinjun Zhang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/633,038

(22) Filed: Dec. 8, 2009

Related U.S. Application Data
(63) Continuation of application No. PCT/CN2008/071479, filed on Jun. 28, 2008.

(30) Foreign Application Priority Data
Aug. 20, 2007 (CN) CN200710143700.6

(51) Int. Cl. H04L 12/56

(52) U.S. Cl. 370/392

(57) ABSTRACT

A method for advertising routing information by a routing device includes: checking whether a routing device is active; by the routing device, generating routing information, and marking the routing information with a check result; and advertising the routing information. With the present invention, a route attribute of routing information is set, so that the routing information can reflect the active or standby state of the active routing device and standby routing device; after the routing information is advertised, the routing of a remote routing device is affected. Thus, the remote routing device always selects the active routing device to forward packets, which ensures the reachability and connectivity of the network.

### CROSS-REFERENCE TO RELATED APPLICATIONS

This application is a continuation of International Application No. PCT/CN2008/071479, filed on Jun. 28, 2008, which claims priority to Chinese Patent Application No. 200710143700.6, filed on Aug. 20, 2007, both of which are hereby incorporated by reference in their entireties.

### FIELD OF THE INVENTION

The present invention relates to a network communication technology, and in particular, to a method and routing device for advertising routing information.

### BACKGROUND OF THE INVENTION

To improve the reliability and security of a network, a redundant routing device, for example, a standby firewall, is often needed in the network. That is, an active routing device and at least a standby routing device need to be set. When the active routing device works normally, the active routing device is used. When the active routing device fails, the standby routing device replaces the active routing device. During interactions between the routing device and routing protocol, however, a packet that should be forwarded to an active routing device is forwarded to a standby routing device. Because the standby routing device does not have the state information of the packet, it discards the packet, which causes packet loss.

For example, two routing devices are generally deployed in the network to improve the security of the network. These two routing devices work in active or standby mode; that is, one routing device is the active routing device, and the other is the standby routing device. From the perspective of an internal network, a Virtual Router Redundancy Protocol (VRRP) may be deployed. As shown in FIG. 1, all uplink traffic that flows from an internal network to an external network may pass through the active routing device over VRRP. In this case, the active routing device maintains all the IP connection information, and the internal network is protected and controlled. However, the downlink traffic that flows from the external network to the internal network must also enter the internal network through the active routing device. If the external network selects a standby routing device to forward a packet, the standby routing device may discard the packet due to the lack of IP connection state information in the standby routing device, as shown in FIG. 2.

Thus, in the prior art, it cannot be guaranteed that a packet always passes through the active routing device even if the active routing device works normally. The packet loss may occur due to being forwarded to the standby routing device.

### SUMMARY OF THE INVENTION

Embodiments of the present invention provide a method and routing device for advertising routing information to reflect the current active or standby state of a routing device by using the route attribute of routing information advertised by the routing device, so that the remote routing device can select an active routing device to forward packets.

A method for advertising routing information in an embodiment of the present invention includes: checking whether a routing device is active; generating, by the routing device, routing information, and marking the routing information with a check result; and advertising the routing information.

A routing device provided in an embodiment of the present invention includes a state detecting module and a routing information generating module. The state detecting module is configured to check whether the routing device is active. The routing information generating module is configured to generate routing information according to the check result of the state detecting module, and mark the routing information with the check result.

In embodiments of the present invention, the routing device advertises routing information that can reflect the active state of the routing device, so that the remote routing device always selects the active routing device to forward packets. Thus, the packets loss due to being forwarded to the standby routing device may be avoided, which guarantees the reachability and connectivity of the network.

### BRIEF DESCRIPTION OF THE DRAWINGS

FIG. 1 is a schematic diagram illustrating the routing by a remote routing device in the prior art;

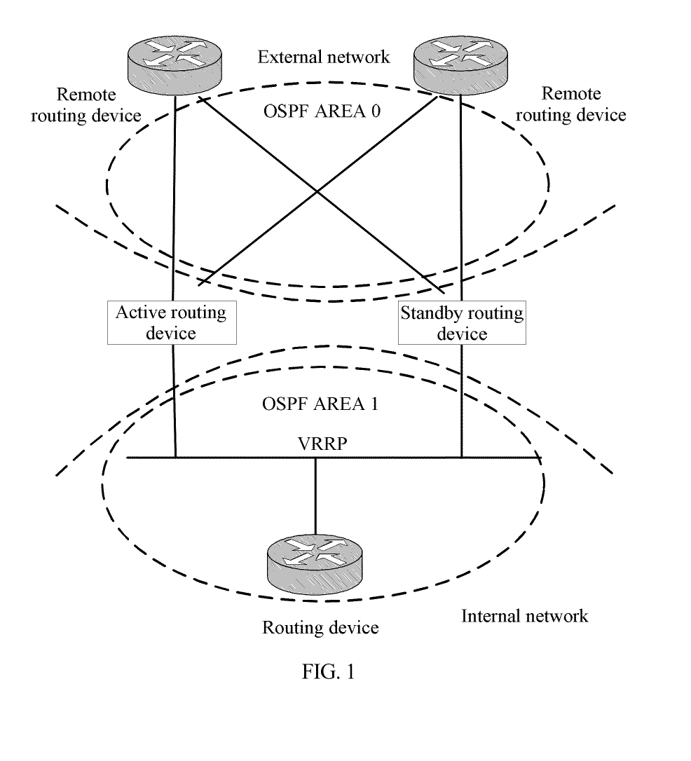

FIG. 2 is a schematic diagram illustrating the loss of packets occurring at a standby routing device in the prior art;

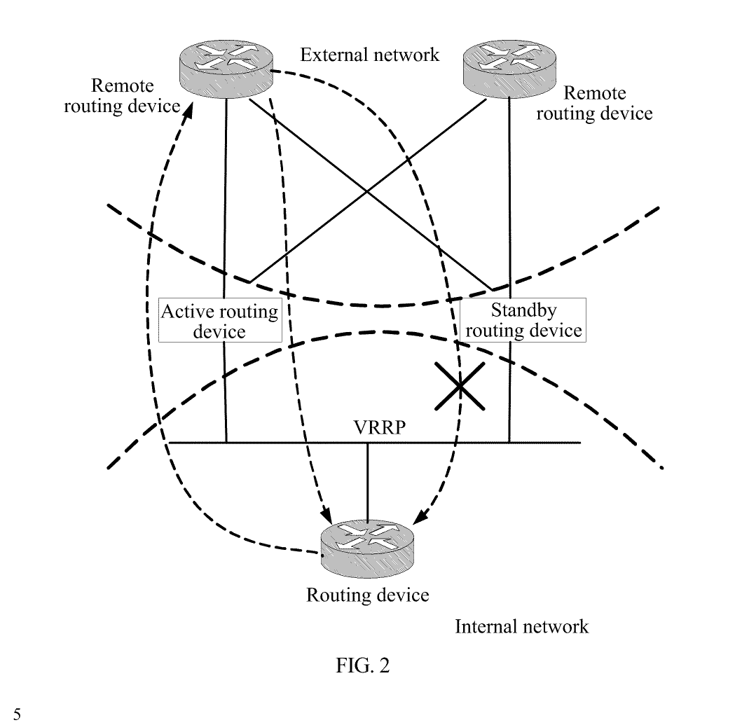

FIG. 3 is a flowchart of a method for advertising routing information by a routing device according to an embodiment of the present invention; and

FIG. 4 shows a structure of a routing device according to an embodiment of the present invention.

### DETAILED DESCRIPTION OF THE INVENTION

In embodiments of the present invention, routing information may reflect the current active or standby state of a routing device according to a route attribute, so that a remote routing device always selects the active routing device to forward packets. In addition, when the active or standby state of the routing device is changed, the routing device generates new routing information that can reflect the changed state, which ensures that the active routing device always advertises routing information that reflects the active state and that the standby routing device always advertises routing information that reflects the standby state. For example, after the standby routing device replaces a faulty active routing device, it generates new routing information according to a route attribute that can reflect the active state, where the routing information reflects the current active state with a route attribute. If the value of the Metric attribute can be reduced or the Type of routes with a higher priority is selected, the original active routing device corresponding to the standby routing device may also make adjustments, and generate new routing information according to the route attribute that can reflect the standby state, where the routing information reflects the current standby state with the route attribute. For example, the Metric value is increased or the Type of routes with a lower priority is selected. Certainly, for the active or standby state, the adjustments of the route attributes are relative. It does not mean that a routing device can be the active or standby routing device only when the route attribute is adjusted to a certain value. Taking the Metric value as an example, the remote routing device considers the routing device with a higher Metric value as the standby routing device; or relative to a routing device with Type 2, a routing device with Type 1 is the active routing device. The preceding comparison of the route attribute in the routing information of the routing device is only an example in embodiments of the present invention. A route attribute may also be directly set to an active state ID. Only the active routing device can advertise routing information that carries the active state ID, and the standby routing device only needs to advertise normal routing information. After receiving the routing information, the remote routing device may select an active routing device to forward packets according to the route attribute of the routing information. For example, the remote routing device may consider a routing device that advertises routing information carrying the active state ID as the active routing device, or a routing device with a smaller Metric value in the routing information as the active routing device. Thus, the uplink and downlink packets can always pass through the active routing device, which solves the problem of packet loss due to packets forwarded to the standby routing device, thus ensuring the reachability and connectivity of the network.

Embodiments of the present invention provide a lot of methods for reflecting the active or standby state of the routing device by using a public attribute or a private attribute. After receiving a route, the remote routing device may check the public attribute or private attribute of the routing information, so as to judge whether the routing device is the active routing device.

For example, the public attributes include Metric, Tag, Type or Forwarding Address in the Open Shortest Path First (OSPF) protocol, Multi-Exit Discriminator (MED), Local Preference, AS-Path or Nexthop in the Border Gateway Protocol (BGP), Metric, Tag or Up/Down Bit in the Intermediate System-to-Intermediate System (ISIS) protocol, and Metric or Hop Count in the Routing Information Protocol (RIP). The private attributes include private attributes customized by companies, such as Huawei attribute. Thus, in different routing protocols, the active or standby state of the routing device may be reflected by changing the public attribute or private attribute. It is understandable to those skilled in the art that the present invention can be used in protocols not mentioned in embodiments of the present invention or in attributes not mentioned in the foregoing protocols. Thus, any changes to protocols or attributes should fall in the scope of protection of the present invention.

The active routing device and standby routing device are two network devices with real-time backup functions, which are used to solve the breakdown of the whole network due to a single point failure in a network device. That is, there is a routing device which is standby besides an active routing device. One routing device is specified as the active routing device, and the other routing device is defined as the standby routing device. The active routing device sends packets from time to time, and the standby routing device detects system failures or line failures by listening to the packets. When the active system fails, the standby routing device acts as the active routing device instead as soon as possible to serve the system uninterruptedly.

The routing protocol is an important part of the routing device software, the core function of which is to: find an optimal path, generate a route, change the IP routing table, and instruct the routing device to forward packets according to the known network topology information and various parameter indexes. According to the routing algorithm, the unicast routing protocol may include a distance vector routing protocol and a link state routing protocol. In the distance vector routing protocol, routing devices send a whole updated routing table, and by learning from each other, grasp the topology of the whole network. In the link state routing protocol, the routing devices broadcast their own link state information, and by learning from each other, grasp the routes of the whole network and find the optimal forwarding path through computation. Although these two routing protocols may have different routing forms, the same task is to find the optimal path in the network and to ensure the connectivity of the network. However, embodiments of the present invention are not limited to any routing protocol or an attribute in the routing protocols, and can be used in the link state routing protocol or distance vector routing protocol. In addition, embodiments of the present invention can guide the packets to the active routing device.

The routing device in embodiments of the present invention includes, but not limited to, a switch, security device and router, where the security device may be a firewall.

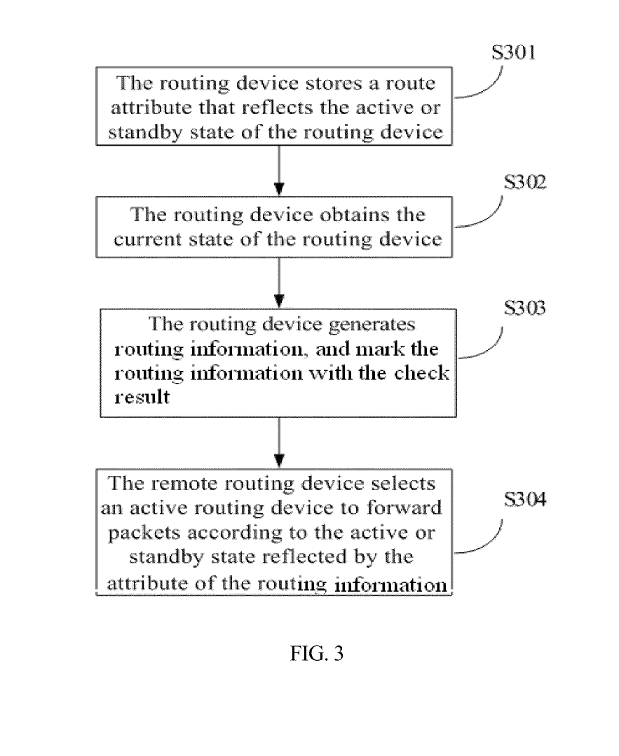

FIG. 3 is a flowchart of a method for advertising routing information by a routing device. In this embodiment, the route attribute of routing information to be advertised by a routing device affect the routing of a remote routing device. That is, the routing information to be advertised by the routing device can reflect the active or standby state of the routing device. The method includes the following steps:

S301. The routing device selects and stores a route attribute that reflects the active or standby state of the routing device, so that when the active or standby state of the routing device is changed, the routing device can uniformly change routing information to be advertised according to the stored route attribute, which avoids a conflict that the active routing device changes one attribute and the standby routing device changes another attribute. This embodiment provides two methods for judging the active or standby state of the routing device according to the route attribute. One is using the active state ID carried in a route attribute, for example, the active state ID in the Tag field. The other is comparing route attributes, for example, Metric and Type, so as to judge which routing device is active. For example, the configured route attribute is stored in the routing device, and different route attribute may be selected to reflect the active or standby state of the routing device according to different routing protocols. For example, for the OSPF protocol, the Type route attribute may be selected to reflect the active or standby state of the routing device. The Type 1 or 2 route attribute is stored in the routing device. If the routing device is active, the Type 1 route attribute is called; if the routing device is standby, the Type 2 route attribute is called. In this embodiment, an independent attribute may be set to carry the active state ID. For example, the active state ID is carried in the Tag field, so that the remote routing device may select the active routing device to forward packets according to whether the received routing information carries the active state ID.

This step is only an optimized solution of the present invention, and is not mandatory in this embodiment of the present invention because only one attribute may be changed when the active or standby state of the routing device is changed. For example, only the Type in the OSPF protocol can be changed. Thus, when the active or standby state of the routing device is changed, only the Type needs to be adjusted, and the stored route attribute does not need to be changed, which avoids a conflict that the active routing device and the standby routing device change different attributes.

In this embodiment, the route attribute is used to reflect the active or standby state of the routing device, and includes an original public attribute and a customized private attribute. When the private attribute is selected, the remote routing device needs to select a proper algorithm. In addition, different attributes need to be set for different routing protocols. For example, for the distance vector routing protocol, link state routing protocol or BGP, different additional attributes need to be set. In the OSPF protocol, attributes such as Metric, Tag, Type or Forwarding Address may be set; in BGP, attributes such as Metric, MED, Local Preference, AS-Path or Nexthop may be set; in the ISIS protocol, attributes such as Metric, Tag or Up/Down Bit may be set; in RIP, attributes such as Metric or Hop Count may be set. For example, by setting the value of the common metric in each protocol, this embodiment sets the metric with a larger value to reflect the standby state of the routing device, and the metric with a smaller value to reflect the active state of the routing device. The remote routing device may select a path with a low metric to forward packets according to the routing protocol. In this case, the remote routing device, after receiving the routing information, may compute metrics needed for passing through the routing device according to the Metric value in the routing information. Thus, the computed route that passes through the active routing device is better than the computed route that passes through the standby routing device. The optimal path may be selected as the route according to the routing principle in the routing protocol. When the Metric value in the active routing information advertised by the active routing device is smaller than the Metric value in the standby routing information advertised by the standby routing device, the metrics needed for passing through the active routing device are less than those needed for passing through the standby routing device. Thus, after the remote routing device parses the received routing information, the remote routing device may select the active routing device to forward packets. Taking the Type in an external routing information advertised by OSPF as an example, it is guaranteed that the Type is 1 when the route passes through the active routing device, and that the Type is 2 when the route passes through the standby routing device. As specified in the OSPF protocol, Type 1 enjoys a higher priority than Type 2 does. Thus, the route that passes through the active routing device is better than the route that passes through the standby routing device. In the OSPF protocol, changing the Metric and Type is only a method for carrying the state ID. This embodiment also provides a method for carrying the state ID by setting the Tag or Forwarding Address attributes of routing information. In BGP, such attributes as MED, Local Preference, AS-Path or Nexthop may be set.

S302. The routing device checks whether the routing device is active, and obtains the current state of the routing device. The routing device may check whether the routing device is active by using a lot of methods. For example, the routing device may work with the VRRP of the internal network to know the current state of the routing device through VRRP. Thus, the routing device may obtain the current state of the routing device through VRRP before advertising routing information.

S303. The routing device generates routing information, and marks the routing information with the check result. In the method for determining the active state by setting a route attribute to carry the active state ID, the routing device may generate and advertise routing information according to the route attribute that reflects the active state stored in step S301 only when the routing device verifies that its current state is active. In the method for determining the active state by comparing the route attribute, the active routing device and the standby routing device need to generate routing information according to the route attribute that reflects the active state stored in step S301. For example, in the OSPF protocol, supposing that the Types of the routing information advertised by the original active routing device and standby routing device are set to 1 (indicating the active state) and 2 (indicating the standby state) respectively, the active routing device and standby routing device change the original attribute of the routing information respectively if finding that their active or standby states are changed. For example, the Type of the original active routing device is changed from 1 to 2, and the Type of the original standby routing device is changed from 2 to 1.

S304. The remote routing device parses the received routing information, and selects the active routing device to forward packets according to the active or standby state reflected by the attribute of the routing information. The remote routing device may select a proper judgment method according to different methods for setting the route attribute in step S301. If the method for determining the active state by carrying the active state ID in a route attribute is used in step S301, the remote routing device, after receiving the routing information, can judge whether the routing device that advertises the routing information is active according to whether the route attribute in the routing information carries the active state ID. For example, after receiving the routing information, the remote routing device may make such judgment according to whether the Tag field in the routing information carries the active state ID. If the method for determining the active state by comparing the route attribute is used in step S301, the remote routing device can determine the active routing device according to the routing protocol without special stipulations. For example, in the method for changing the Metric value, the routing protocol may always select the optimal path to forward packets. Thus, after receiving the routing information, the remote routing device may compute metrics needed for passing through each routing device according to the Metric value of routing information. Then, the remote routing device may select a routing device with fewer metrics to forward packets according to the routing protocol; that is, it selects a routing device with a smaller Metric value as the active routing device. The method for determining the active state by comparing the Metric value is ordinary and applicable to all the routing protocols. However, in different routing protocols, another route attribute may also implement the function of the Metric value. For example, in the OSPF protocol, the remote routing device may select a routing device with the Type of routing information with a higher priority to forward packets according to the OSPF protocol.

The method for advertising routing information in this embodiment reflects the current state of the routing device with a route attribute. In different protocols, the current state of the routing device is reflected by different route attributes and in different modes. The following gives an overview by taking the OSPF protocol as an example. In the OSPF protocol, attributes such as Metric, Tag, Type or Forwarding Address may be set. For example, for the Metric or Type attribute, the active routing device may be determined by comparing the Metric or Type value of the routing information advertised by the active routing device and standby routing device. As specified in the OSPF protocol, a routing device with a smaller Metric value or Type of a higher priority is the active routing device; for the Tag or Forwarding Address attribute, the active routing device only needs to advertise routing information carrying the active state ID in the route attribute, while the standby routing device only needs to advertise normal routing information. In other routing protocols, the preceding technical effect may be achieved by setting different attributes, for example, MED, Local Preference, AS-Path or Nexthop in BGP; Metric, Tag or Up/Down Bit in ISIS; and Metric or Hop Count in RIP. In addition, private attributes customized by companies can be used to reflect the current active or standby state of the routing device. In this embodiment, a route attribute in the routing information is set, so that the remote routing device can select the active routing device to send packets, which ensures the reachability and connectivity of the network. In addition, after the current state of a routing device is changed, the attributes of the routing information advertised by the routing device are changed accordingly, which ensures that the remote routing device always selects the active routing device to forward packets even if the states of the active routing device and standby routing device are changed.

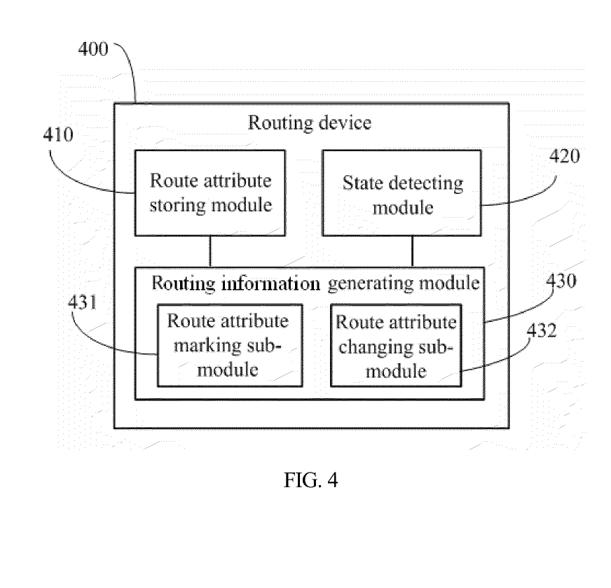

An embodiment of the present invention also provides a routing device that combines the preceding method for advertising routing information. FIG. 4 shows a structure of a routing device 400 in an embodiment of the present invention. The routing device 400 includes a state detecting module 420 and a routing information generating module 430. The state detecting module 420 is configured to check whether the routing device 400 is active, i.e. check the current active or standby state, so that the routing information can reflect the active or standby state of the routing device correctly. The routing information generating module 430 is configured to generate routing information according to the check result of the state detecting module 420, mark the routing information with the check result, and advertise the generated routing information. If the routing device is active, it generates routing information according to the route attribute that reflects the active routing device, and advertises the routing information. If the routing device is standby, it generates routing information according to the route attribute that reflects the standby routing device, and advertises the routing information. If the Tag or Forwarding Address attribute carries the active state ID, the active routing device rather than the standby routing device needs to generate routing information. For example, in the OSPF protocol, supposing that the Types of the routing information advertised by the original active routing device and standby routing device are set to 1 (indicating the active state) and 2 (indicating the standby state) respectively, the active routing device and standby routing device change the original attributes of the routing information respectively if finding that their active or standby states are changed. For example, the Type of the original active routing device is changed from 1 to 2, and the Type of the original standby routing device is changed from 2 to 1. With the state change of the active routing device and standby routing device, the route attributes in the routing information advertised by the active routing device and the standby routing device are also changed. Thus, in the preceding embodiment, the current state of a routing device is reflected by using a route attribute. In addition, the route attribute that reflects the changed state can be adjusted as soon as the state of the routing device is changed.

This embodiment provides two methods for judging the active or standby state of the routing device according to the route attributes. One is using the active state ID carried in a route attribute, and the other is comparing route attributes, for example, Metric and Type, so as to judge which routing device is active. Thus, the routing information generating module 430 in this embodiment may further include a route attribute marking sub-module 431 and/or route attribute changing sub-module 432. The route attribute marking sub-module 431 is configured to mark routing information with the active state ID by using a route attribute when the routing device 400 is active. For example, the active state ID is carried in the Tag field. The route attribute changing sub-module 432 is configured to change the route attributes of the routing information advertised by the routing device 400 when the routing device 400 is active, so that the remote routing device can determine the active routing device by comparing the route attributes in the received routing information. For example, in the OSPF protocol, the active or standby state may be reflected by changing the Type attribute. If the routing device is active, the Type is changed to 1; if the routing device is standby, the Type is changed to 2. According to the OSPF protocol, the remote routing device may select a routing device with the Type of a higher priority to forward packets. The routing device 400 further includes a route attribute storing module 410, which is configured to store the route attribute that reflects the active routing device and standby routing device, so that the routing device can uniformly change the advertised routing information according to the stored route attribute when the active or standby state of the routing device is changed, which avoids a conflict that the active routing device changes one attribute and the standby routing device changes another attribute. The route attribute storing module 410 is only an optimized solution of the present invention, and is not mandatory in this embodiment of the present invention because only one attribute may be changed when the active or standby state of the routing device is changed. For example, only the Type in the OSPF protocol can be changed. Thus, when the active or standby state of the routing device is changed, only the Type needs to be adjusted.

By combining with the preceding method for advertising routing information, the routing device enables the remote routing device to select the active routing device to forward packets, which solves the problem of packet loss due to the packets forwarded to the standby routing device, thus ensuring the reachability and connectivity of the network.

In embodiments of the present invention, an attribute of the routing information advertised by a routing device can reflect the active or standby state of the routing device. In addition, the active or standby state reflected by the attribute corresponds to the current active or standby state of the routing device. That is, when the active or standby state of the routing device is changed, the routing device needs to change the attribute accordingly to reflect the new state of the routing device. Thus, in embodiments of the present invention, in different routing protocols, different attributes may be used to reflect the active or standby state of the routing device. The method for advertising routing information in embodiments of the present invention is applicable in all the routing protocols. If no available attribute may be set in a routing protocol, private attributes may be customized to reflect the active or standby state of the routing device. For example, Huawei attribute may be used to reflect the active or standby state of the routing device. In embodiments of the present invention, a route attribute in the routing information is used to reflect the current state of the routing device. In addition, setting methods may vary with the routing protocols or route attributes. Thus, any changes regarding the routing protocols and route attributes should fall in the scope of protection of the present invention.

Through the preceding description of embodiments of the present invention, it is understandable to those skilled in the art that embodiments of the present invention may be implemented by hardware or by software in combination with a necessary hardware platform. Thus, the technical solution of the present invention may be made into software. The software may be stored in a non-volatile storage medium (for example, a CD-ROM, a USB disk, and a mobile hard disk), and include several instructions that instruct a computer device (such as a personal computer, a server, or a network device) to perform the methods provided in each embodiment of the present invention.

Although the invention has been described through several exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the claims or their equivalents.

What is claimed is:

1. A method for advertising routing information, comprising:
checking whether a routing device is active;
generating, by the routing device, routing information;
marking the routing information with a check result; and
advertising the routing information.

2. The method of claim 1, before generating the routing information, further comprising: storing a route attribute that reflects an active or standby state of the routing device.

3. The method of claim 1, wherein the marking the routing information with the check result comprises:
if the routing device is active, marking the routing information with a route attribute carrying an active state ID.

4. The method of claim 1, wherein the marking the routing information with the check result comprises:
if the routing device is active, changing a route attribute of routing information to be advertised by the routing device, whereby a remote routing device can determine an active routing device by comparing the route attributes in the received routing information.

5. The method of claim 2, wherein the route attribute comprises Metric, Tag, Type or Forwarding Address in an Open Shortest Path First (OSPF) protocol.

6. The method of claim 2, wherein the route attribute comprises Metric, Multi-Exit Discriminator (MED), Local Preference, AS-Path or Nexthop and Origin in a Border Gateway Protocol (BGP).

7. The method of claim 2, wherein the route attribute comprises Metric, Tag or Up/Down Bit in an Intermediate System-to-Intermediate System (ISIS) protocol.

8. The method of claim 2, wherein the route attribute comprises Metric or Hop Count in a Routing Information Protocol (RIP).

9. The method of claim 4, wherein the changing the route attributes of routing information to be advertised by the routing device comprises: changing the value of Metric of routing information generated by the active routing device to be smaller than the value of Metric of routing information generated by a standby routing device.

10. The method of claim 4, wherein the changing the route attributes of routing information to be advertised by the routing device comprises: changing the Type of routing information generated by the active routing device to enjoy a higher priority than the Type of routing information generated by a standby routing device does.

11. The method of claim 1, wherein after advertising the routing information, the method further comprises:
parsing, by a remote routing device, the received routing information, and selecting an active routing device to forward packets.

12. A routing device, comprising:
a state detecting module, configured to check whether the routing device is active; and
a routing information generating module, configured to generate routing information according to a check result of the state detecting module, and mark the routing information with the check result.

13. The routing device of claim 12, further comprising a route attribute storing module, configured to store a route attribute that reflects an active or standby state of the routing device.

14. The routing device of claim 12, wherein the routing information generating module comprises a route attribute marking sub-module, configured to mark the routing information with a route attribute carrying an active state ID when the routing device is active.

15. The routing device of claim 12, wherein the routing information generating module comprises a route attribute changing sub-module, configured to change route attributes of routing information to be advertised by the routing device when the routing device is active, whereby a remote routing device can determine an active routing device by comparing the route attributes in the received routing information.

16. A computer readable medium including code for checking whether a routing device is active;
generating, by the routing device, routing information;
marking the routing information with a check result; and
advertising the routing information.
